(19) United States
(12) Patent Application Publication
(10) Pub. No.: US 2022/0289544 A1
(43) Pub. Date: Sep. 15, 2022

(54) OPTIMIZATION CONTROL METHOD FOR STABLE OPERATION OF AN AERIAL WORK PLATFORM

(71) Applicant: Hunan Sinoboom Intelligent Equipment Co., Ltd., Changsha City (CN)

(72) Inventors: Bin Pan, Changsha City (CN); Guoliang Liu, Changsha City (CN)

(73) Assignee: Hunan Sinoboom Intelligent Equipment Co., Ltd., Changsha City (CN)

(21) Appl. No.: 17/373,895

(22) Filed: Jul. 13, 2021

(30) Foreign Application Priority Data
Mar. 10, 2021 (CN) 202110260843.5

(51) Int. Cl. B66F 17/00; B66F 11/04

(52) U.S. Cl. CPC B66F 17/006; B66F 11/046

(57) ABSTRACT

Provided is an optimization control method for stable operation of an aerial work platform. For an articulated boom type aerial work platform which does not overturn in three preset operational states, the maximum angle βₘₐₓ of a folding boom angle β is substituted into a known first stability control function L=g (α, β, S) to obtain an optimized second stability control function L=f (α, S). The three preset operational states include: State I—a folding boom is fully extended at a maximum angle, and a main boom is fully retracted at a maximum angle; State II—the folding boom is fully retracted at a minimum angle, and the main boom is fully retracted at a maximum angle; and State III, the folding boom is fully retracted at a maximum angle, and the main boom is fully retracted horizontally.

### CROSS-REFERENCE TO RELATED APPLICATIONS

This application claims priority to Chinese patent application No. 202110260843.5, filed Mar. 10, 2021, the entire contents of which are incorporated herein by reference.

### TECHNICAL FIELD

The present disclosure relates to the technical field of aerial work platforms, and in particular to an optimization control method for stable operation for an aerial work platform.

### BACKGROUND

As shown in FIG. 1, an articulated boom type aerial work platform consists mainly of five parts: a base frame 1, a turntable 2, a folding boom 3, a main boom 4 and a platform 5. The base frame 1 provides a force application point with the ground for the whole vehicle. Taking the base frame 1 with four tires as an example, in order to prevent the aerial work platform from overturning during operation, the center of gravity of the whole vehicle needs to fall within the rectangular frame defined by the four tires. During the boom extension operation, the positions of centers of gravity of the base frame 1 and the turntable 2 are not changed and located within the rectangular frame, while the positions of centers of gravity of the folding boom 3 and the main boom 4 vary with a folding boom angle β, a folding boom extension length S, a main boom angle α and a main boom extension length L. Therefore, to ensure the stability of the whole vehicle, there is a need to adjust the four variables α, β, L and S reasonably. To ensure safety, stability control functions are often constructed in advance to coordinate the values of variables with reference to the calculation results of the stability control functions. For example, α, β and S are usually taken as independent variables and L as a dependent variable, a stability control function L=g (α, β, S) is constructed according to a moment relation ΣM_{stability}=ΣMₜᵤᵣₙₒᵥₑᵣ during critical turnover. An actual extension length L_{actual} of the main boom is controlled to be less than a calculation value of L=g (α, β, S) when implementing operation, so the stability of the whole vehicle can be ensured.

However, the stability control function constructed with three variables of a, β, L and S as independent variables and the other as dependent variable is still not simple enough. Therefore, how to construct a stability control function with fewer variables as independent variables has become a technical problem to be urgently solved by those skilled in the art.

### SUMMARY

In view of this, the present disclosure provides an optimization control method for stable operation of an aerial work platform. The optimization control method ensures the stability of an articulated boom type aerial work platform by combining a more simplified stability control function with a simple folding boom adjustment method, and is beneficial to simplifying a control program, thereby improving the reliability.

For this purpose, the optimization control method for stable operation of an aerial work platform is provided by the present disclosure. The aerial work platform is an articulated boom type aerial work platform, and the aerial work platform is designed not to overturn in three preset operational states. The optimization control method includes:

substituting the maximum angle βₘₐₓ of a folding boom angle θ into a known first stability control function L=g (α, β, S) of the aerial work platform, to obtain an optimized second stability control function L=f (α, S), where L is a main boom extension length, α is a main boom angle, and S is a folding boom extension length;

adjusting an actual extension length L_{actual} of a main boom according to the second stability control function when in operation; and

adjusting a folding boom in a following way:

in a boom unfolding process, the folding boom extension length S is always kept at zero before the folding boom is pivoted to the maximum angle βₘₐₓ; and

in a boom folding process, the folding angle θ is always kept at the maximum angle βₘₐₓ before the folding boom is retracted to zero elongation;

The three preset operational states include:

State I—the folding boom angle θ reaches the maximum angle βₘₐₓ, the folding boom extension length S reaches the maximum length Sₘₐₓ, the main boom angle α reaches the maximum angle αₘₐₓ, and the main boom extension length L is zero;

State II—the folding boom is horizontal, the folding boom extension length S is zero, the main boom angle α reaches the maximum angle αₘₐₓ, and the main boom extension length L is zero; and

State III—the folding boom angle θ reaches the maximum angle βₘₐₓ, the folding boom extension length S is zero, the main boom is horizontal, and the main boom extension length L is zero;

The maximum angle αₘₐₓ, the maximum angle βₘₐₓ and the maximum length Sₘₐₓ are all structural design values of the aerial work platform.

It can be known according to the above technical scheme that, the optimization control method provided by the present disclosure is applicable to the articulated boom type aerial work platform which won't overturn in the three preset operational states. Under these conditions, combined with a simple folding boom adjustment method, it is guaranteed that the new function L=f (α, S) obtained by substituting the maximum angle βₘₐₓ of the folding boom angle θ into any known stability control function L=g (α, β, S) is also a stability control function, and in operation the actual extension length L_{actual} of the main boom can be adjusted according to the new function. Since the new stability control function L=f (α, S) is only related to two independent variables, i.e., the main boom angle α and the folding boom extension length S, it is beneficial to simplifying the control program and enhancing the reliability of the program.

### BRIEF DESCRIPTION OF THE DRAWINGS

To explain the embodiments of the present disclosure or the technical schemes of the existing technology more clearly, the drawings required in the embodiments or the description of the existing technology will be briefly introduced below. Obviously, the drawings in the description below are merely embodiments of the present disclosure, and other drawings may also be obtained by those having ordinary skilled in the art based on the provided drawings without creative efforts.

FIG. 1 is a schematic diagram of a structure of an aerial work platform to which an optimization control method provided by the present disclosure is applicable;

FIG. 2 is a schematic diagram of the aerial work platform shown in FIG. 1 in State I;

FIG. 3 is a schematic diagram of the aerial work platform shown in FIG. 1 in State II; and

FIG. 4 is a schematic diagram of the aerial work platform shown in FIG. 1 in State III.

### REFERENCE NUMERALS

1. Base frame; 2. Turntable; 3. Folding boom; 4. Main boom; 5. Platform; α. Main boom angle; β. Folding boom angle; L. Main boom extension length; S. Folding boom extension length.

### DETAILED DESCRIPTION

For easy understanding, the present disclosure will be further described with reference to the accompanying drawings.

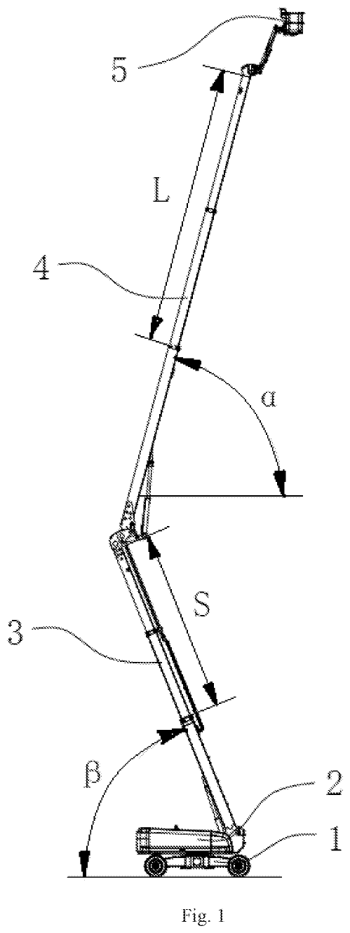

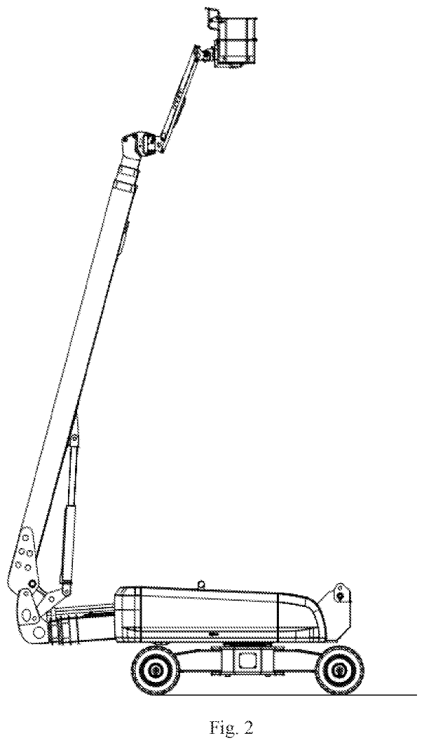

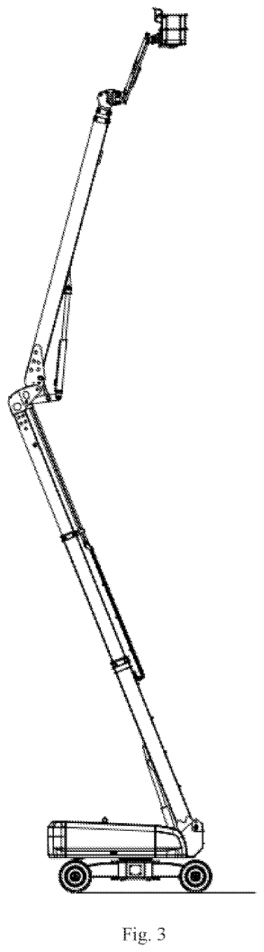

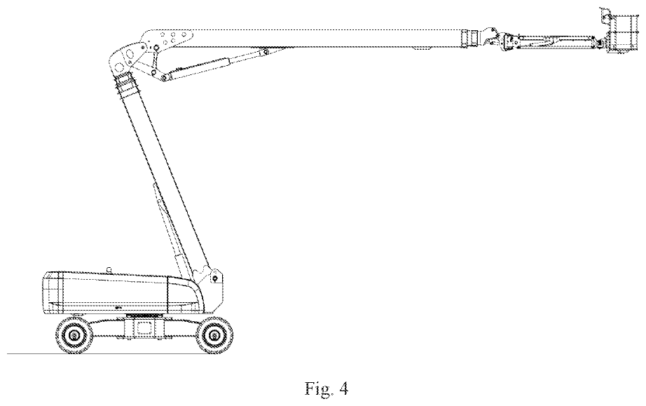

Referring to FIG. 1, the optimization control method for stable operation of an aerial work platform provided by the present disclosure is applicable to an articulated boom type aerial work platform. The articulated boom type aerial work platform is designed not to overturn in three states shown in FIGS. 2-4. In State I, a folding boom angle θ reaches the maximum angle βₘₐₓ, a folding boom extension length S reaches the maximum length Sₘₐₓ, a main boom angle α reaches the maximum angle αₘₐₓ, and a main boom extension length L is zero, as shown in FIG. 2. In State II, a folding boom is horizontal, the folding boom extension length S is zero, the main boom angle α reaches the maximum angle αₘₐₓ, and the main boom extension length L is zero, as shown in FIG. 3. In State III, the folding boom angle θ reaches the maximum angle βₘₐₓ, the folding boom extension length S is zero, the main boom is horizontal, and the main boom extension length L is zero, as shown in FIG. 4. It should be noted that the maximum angle αₘₐₓ, the maximum angle βₘₐₓ and the maximum length Sₘₐₓ are all structural design values of the aerial work platform.

For the articulated boom type aerial work platform with a certain structural design, a stability control function L=g (α, β, S) can be constructed according to a moment relation ΣM_{stability}=ΣMₜᵤᵣₙₒᵥₑᵣ of critical turnover in existing technologies. It should be understood that, a specific structural equation of L=g (α, β, S) depends on the design dimensions and weight distribution of the aerial work platform. However, as long as the aerial work platform does not overturn in the three states shown in FIGS. 2-4, the stability control function L=g (α, β, S) can be optimized to a stability control function with less independent variables through the optimization control method provided by the present disclosure. Specifically, the maximum angle βₘₐₓ of the folding boom angle θ is substituted into the known stability control function L=g (α, β, S), and the variable β is eliminated, thereby obtaining a new stability control function L=f (α, S), which only has two independent variables, i.e. α and S.

In operation, an actual extension length L_{actual} of the main boom is adjusted according to L=f (α, S), that is, L_{actual} should be less than a calculation value of L=f (α, S). The folding boom is adjusted in a following way: in a boom unfolding process, the folding boom extension length S is always kept at zero before the folding boom is pivoted to the maximum angle βₘₐₓ; and in a boom folding process, the folding boom angle θ is always kept at the maximum angle βₘₐₓ before the folding boom is retracted to zero elongation. The stability of the whole vehicle is only related to three factors: the folding boom extension length S, the main boom angle α and the main boom extension length L, which not only ensures the stability, but also ensures the operation range.

Referring to FIG. 1, with the increase of the folding boom angle β, the centers of gravity of the main boom 4 and the folding boom 3 move forward; with the increase of the folding boom extension length S, the centers of gravity of the main boom 4 and the folding boom 3 move backward; when the main boom angle α is greater than 0, with the increase of the main boom angle α, the center of gravity of the main boom 4 moves backward; when the main boom angle α is less than 0, with the decrease of the main boom angle α, the center of gravity of the main boom 4 moves backward; and with the increase of the main boom extension length L, the center of gravity of the main boom 4 moves forward. It can be seen that, when the articulated boom type aerial work platform operates based on the folding boom adjustment method, the states shown in FIG. 2 and FIG. 3 are states in which the backward stability is the worst. As mentioned above, it is known that these two states are stable, so the backward stability of the machine always meets requirements, that is, the machine never overturns backward. On the other hand, as the state shown in FIG. 4 is also stable, the function L=f (α, s) is ensured to have a non-negative solution. When the folding boom angle θ decreases, the folding boom extension length S increases or the main boom angle α changes, the center of gravity of the boom moves backward, and in combination with the aforementioned limiting conditions that make the backward stability of the machine always meet the requirements, it is guaranteed that L=f (α, S) has a solution within the range of (0, Lₘₐₓ), that is, the stability of the whole vehicle can always be guaranteed by controlling the length of the main boom. It should be noted that, the maximum length Lₘₐₓ is a structural design value of the aerial work platform.

The description of the disclosed embodiments enables those having ordinary skill in the art to implement or use the present disclosure. Various modifications to these embodiments will be readily apparent to those having ordinary skill in the art, and the generic principles defined herein may be embodied in other embodiments without departing from the scope of the present disclosure. Therefore, the present disclosure is not limited to these embodiments shown herein, but rather has the broadest scope consistent with the principles and novel features disclosed herein.

What is claimed is:

1. An optimization control method for stable operation for an aerial work platform, wherein the aerial work platform is an articulated boom type aerial work platform including a base frame, a turntable connected to the base frame, a folding boom connected to the turntable, and a main boom connected to the folding boom, wherein the folding boom is extendable to a folding boom extension length S between a minimum extension length of 0 and a maximum extension length Sₘₐₓ, and can pivot relative to the base frame to define a folding boom angle θ relative to horizontal, wherein the main boom is extendable to a main boom extension length L between a minimum extension length of 0 and a maximum extension length Lₘₐₓ, and can pivot relative to the folding boom to define a main boom angle α relative to horizontal, and further wherein the aerial work platform does not overturn in three preset operational states, the optimization control method comprising:
substituting a maximum angle βₘₐₓ of the folding boom angle θ into a known first stability control function L=g (α, β, S) of the aerial work platform, to obtain an optimized second stability control function L=f (α, S);
adjusting the main boom to an actual extension length Lacteal according to the second stability control function in operation; and
adjusting the folding boom as follows:
in a boom unfolding process, the folding boom extension length S is always kept at zero before the folding boom is pivoted to the maximum angle βₘₐₓ; and
in a boom folding process, the folding boom angle θ is always kept at the maximum angle βₘₐₓ before the folding boom is retracted to a folding boom extension length of 0;
the three preset operational states comprise:
State I—the folding boom angle β reaches the maximum angle βₘₐₓ, the folding boom extension length S reaches the maximum length Sₘₐₓ, the main boom angle α reaches a maximum angle αₘₐₓ, and the main boom extension length L is zero;
State II—the folding boom is horizontal, the folding boom extension length S is zero, the main boom angle α reaches the maximum angle αₘₐₓ, and the main boom extension length L is zero; and
State III—the folding boom angle θ reaches the maximum angle βₘₐₓ, the folding boom extension length S is zero, the main boom is horizontal, and the main boom extension length L is zero;
wherein the maximum angle αₘₐₓ, the maximum angle βₘₐₓ and the maximum extension length Sₘₐₓ are all structural design values of the aerial work platform
